(19) United States
(12) Patent Application Publication
(10) Pub. No.: US 2004/0029978 A1
(43) Pub. Date: Feb. 12, 2004

(54) Surfactants formed by surface-modified mineral nanoparticles

(76) Inventor: Jean-Yves Chane-Ching, Eaubonne (FR)

Correspondence Address: BURNS DOANE SWECKER & MATHIS L L P, POST OFFICE BOX 1404, ALEXANDRIA, VA, 22313-1404, US

(21) Appl. No.: 10/275,821

(22) PCT Filed: May 9, 2001
(86) PCT No.: PCT/FR01/01399

(30) Foreign Application Priority Data
May 10, 2000 (FR) 00/05957

(51) Int. Cl. C09K 3/00

(52) U.S. Cl. 516/9

(57) ABSTRACT

The invention concerns a surfactant formed by at least a particle with nanometric dimensions based on a metal oxide, hydroxide and/or oxy hydroxide, at the surface of which are bound hydrophobic organic chains, the bonds between said chains and said particle surface being non-homogeneously distributed on said surface, such that the resulting modified surface particle has an actual amphiphilic character. The invention also concerns emulsifying compositions comprising surface-modified particles with nanometric dimensions which can be said type of surfactants, and methods for preparing said emulsifying compositions.

The present invention relates to emulsifying compositions comprising surfactants formed of solid surface-modified particles, to the said surfactants, as well as to methods of preparation of such compositions.

The surfactants which are currently known are generally molecules or macromolecules with amphiphilic characteristics, that is to say having on the one hand a hydrophilic region and on the other hand a hydrophobic region. This particular structure induces an orientation of these molecules when they are present at interfaces of the liquid/liquid, liquid/gas or liquid/solid type.

In other words, the surfactants can be adsorbed at these interfaces. This adsorption causes a lowering of the interfacial tension and thus permits a reduction in the free energy of the systems which contain a substantial interfacial area, which brings about their stabilisation (foams, emulsions, . . . ). The term surfactant derives from this reduction in the interfacial tension which creates the phenomenon of orientation of the molecules.

Typically, a surfactant is a molecule consisting of one or more ionic or nonionic hydrophilic group(s) and one or more hydrophobic chain(s), most often hydrocarbon. It is the exact nature of these two groups which determines the surfactant properties of the molecule obtained.

It should therefore be emphasised that the structure of a molecular surfactant is generally relatively fixed. For this reason it is difficult in the general case to provide a surfactant with properties other than the properties associated with its amphiphilic nature.

Moreover, during certain stages of concentration (drying, . . . ) of formulations-using molecular surfactants an undesirable parasitic segregation of these agents, associated with their molecular nature, is often observed.

So as to overcome these difficulties, attempts have been made over the course of the last few years to develop solid particles which simultaneously have macroscopic characteristics and amphiphilic characteristics. These particles, sometimes designated by the term “Janus”, referring to the Roman god with two faces turned towards the past and the future, have a hydrophobic face and a hydrophilic face in the manner of a molecular surfactant. For further details on the subject of these particular solids, reference could be made especially to the article by De Gennes et al, “Nanoparticles and Dendrimers: hopes and illusions” in Croat.Chem.Acta, 1998, volume 71(4), pages 833-836.

In fact, one of the advantages of these solid particles is that, due to their macroscopic characteristics, they have a reduced mobility relative to the usual molecular surfactants.

However, if these amphiphilic particles behave effectively in a particular fashion at interfaces of the water/oil type, it could nevertheless not be considered that they might be substituted for the conventional molecular surfactants. On this subject, it should be emphasised in particular that these particles cannot for example be used by way of emulsifying agents, especially because of their substantial size and their not very well marked amphiphilic characteristics.

Thanks to the work by the inventors it has now been discovered that it is possible to modify the surface of a solid particle of nanometre dimensions by organic chains with hydrophobic characteristics in such a way as to obtain a solid structure of small dimensions and having sufficiently pronounced amphiphilic characteristics to ensure a role as emulsifying agent.

On the basis of this discovery, a first object of the present invention is to provide compositions comprising surfactants having, in addition to marked emulsifying characteristics, interesting physical and/or chemical properties which are not associated with these amphiphilic characteristics.

A further object of the invention is to provide compositions comprising surfactants having a sufficient dimension to give them a reduced mobility and capable nevertheless of being substituted for conventional molecular surfactants, at least in certain applications, and in particular in emulsification processes.

Another object of the invention is to provide emulsifying compositions based on surfactants of a solid nature which in an advantageous manner can replace the emulsifying compositions generally used, for example for the production of emulsions, inverse emulsions or multiple emulsions, ensuring sufficient stabilisation of the emulsion whilst also benefiting from the solid nature and the physico-chemical properties of the surfactants used.

Thus according to a first aspect the present invention relates to an emulsifying composition comprising particles of nanometre dimensions based on a metal oxide, hydroxide and/or oxy hydroxide, on the surface of which organic chains with hydrophobic characteristics are bonded, the said composition having specifically an emulsifying nature such that it permits a stabilised emulsion of the water-in-oil or oil-in-water type to be produced, this emulsion being characterised by a dispersed phase content greater than or equal to 20%, preferably greater than or equal to 30%, and preferably greater than or equal to 40%, and in which the average size of the drops forming the dispersed phase is less than or equal to 5 microns, and preferably less than or equal to 3 microns.

The term “stabilised” emulsion is understood, in the sense of the present invention, to mean an emulsion of the water-in-oil type (inverse emulsion) or of the oil-in-water type (direct emulsion) of which the structure remains stable after submission to centrifugation conducted at a speed greater than or equal to 4000 r.p.m. and for a duration of at least twenty minutes.

In the majority of cases, the emulsifying compositions of the present invention have sufficient emulsifying characteristics to permit the production of stabilised emulsions of the water-in-oil type (inverse emulsions) characterised by aqueous phase contents greater than or equal to 40%, and in which the average size of the drops of the dispersed phase is at most 5 microns.

Preferably, the particles of nanometre dimensions based on a metal oxide, hydroxide and/or oxyhydroxide which are present in the emulsifying compositions of the present invention, on the surface of which organic chains with hydrophobic characteristics are bonded, are such that on the surface of the majority of these particles the bonds between the said chains and the surface are distributed inhomogeneously, in such a way that each of the particles surface-modified in this way has effective amphiphilic characteristics, that is to say that when it is placed in a biphase water/oil medium such as a biphase medium of the water/ethyl acetate, water/hexane or water/octanol type the said particle is located specifically at the interface between the two phases present. These amphiphilic characteristics can in particular be demonstrated using a test of the type described by Nakahama et al in Langmuir, volume 16, pages 7882-7886 (2000).

The surfactants formed by such particles of nanometre dimensions surface-modified by organic chains with hydrophobic characteristics, distributed inhomogeneously over the surface, such that the surface-modified particle has effective amphiphilic characteristics, are novel and constitute, according to one particular aspect, another object of the present invention.

Without wishing to be associated with any particular theory, it appears that the effect amphiphilic characteristics of the surfactants present in the compositions according to the present invention are explained by the fact that these surfactants have a structure comprising specifically a zone (1) with substantially hydrophilic characteristics, at least partially due to the hydrophilic characteristics of the particle surface, and a zone (2) with substantially hydrophobic characteristics, due to the presence of the chains with hydrophobic characteristics.

The term “particle of nanometre dimensions” is understood to mean, in the sense of the present invention, an isotropic or anisotropic particle of which the average characteristic dimension(s) is or are between 2 and 100 nm.

The particles of nanometre dimensions according to the invention are advantageously of isotropic or spherical morphology. Furthermore, the average diameter of the particles of nanometre dimensions present within the compositions according to the invention is advantageously between 3 and 40 nm, and preferably between 4 and 20 nm.

Moreover, the said particles of nanometre dimensions are specifically particles based on a metal oxide, hydroxide and/or oxy hydroxide. They are advantageously based on an oxide, hydroxide and/or oxyhydroxide of at least one metal chosen from amongst cerium, aluminium, titanium or silicon.

In addition, and regardless of the compound which is contained in them, the particles present within the compositions according to the invention specifically have, intrinsically, a surface with hydrophilic characteristics. These hydrophilic characteristics are generally ensured by the presence of hydrophilic groups on the surface of the particle. These groups may be neutral (—OH, COOH, PO₄H, for example) or preferably charged, particularly of the —O(H) . . . H⁺, —OH . . . OH or —CO₃²⁻ type, which then gives the particle a non-zero surface charge.

In the case of charged particles, the absolute value of the charge per unit area, expressed relative to the total surface of the particle, is, in the presence of the bonded organic chain(s), advantageously greater than 5 micro-coulombs per cm², and preferably greater than 10 micro-coulombs per cm².

The term “organic chain with hydrophobic characteristics” for its part designates in a general manner an organic chain having a hydrophilic/lipophilic balance such that the said chain is soluble in a hydrophobic solvent and less soluble, advantageously insoluble, in water.

In a preferred manner, the “organic chains with hydrophobic characteristics” according to the invention are chains within which the chemical groups with hydrophobic characteristics, of the type with alkyl chains for example, represent at least 10% by mass, preferably at least 20% by mass and advantageously 30% by mass in the said chains. Thus the organic chains with hydrophobic characteristics according to the invention can in particular be alkyl chains, or even alkyl chains modified by the presence of hydrophilic groups, of the ethoxyl type for example, wherein these groups with hydrophilic characteristics do not represent more than 90% by mass and advantageously represent less than 70%.

Thus the organic chains with hydrophobic characteristics bonded to the surface of the particles present within the compositions according to the invention are preferably alkyl chains comprising from 6 to 30 carbon atoms, and preferably from 8 to 18 carbon atoms, or polyoxyethylene monoalkyl ethers of which the alkyl chain comprises from 8 to 30 carbon atoms, preferably from 8 to 18 carbon atoms, and of which the polyoxyethylene part comprises from 1 to 10 ethoxyl —CH₂CH₂O— groups.

The number of carbon atoms as well as the number of ethoxyl groups which may be present can be adapted as a function of the respectively hydrophobic and hydrophilic properties which are sought for the solid surfactants present within the compositions according to the invention.

On this subject it may be noted that the hydrophilic characteristics are ensured both by the hydrophilic nature of the surface of the particle and by the hydrophilic parts, of the ethoxyl group type, which may be present in the organic chains bonded to the particle. The hydrophobic characteristics are for their part ensured by the hydrophobic parts, of the alkyl chain type, of the organic chains.

Regardless of the nature of the organic chains with hydrophobic characteristics which are used, one of their principle characteristics is that they are specifically bonded by strong bonds to the surface of the particles of nanometre dimensions.

Although the exact nature of the bonds existing between the organic chains and the surface of the particles can vary to quite a large extent, in the sense of the invention it will be considered that a bond exists between an organic chain and the surface of a particle if the energy used in order to join the organic chain and the said surface is greater than a bonding energy of the electrostatic type or hydrogen bonding.

Thus, according to a first variant the bond between the organic chains and the surface of the particle is ensured by the presence at one of the ends of each of the said chains of an ionic group which induces a complexing bond with one of the metal cations present on the surface of the particles. In this case the particles present are partially complexed by molecular surfactants of the ionic type.

It appears that the substantially hydrophobic characteristics of the zone (2) defined previously for the solid surfactants present in the compositions according to the invention are then ensured by the presence of the hydrophobic chains of the molecular surfactants used, the at least predominantly hydrophilic characteristics of the zone (1) being for their part due to the hydrophilic surface of the particle and to any residual surface charge not participating in the complexing of the molecular surfactants of the ionic type which are bonded to the surface.

In this first variant, especially in such a way that the amphiphilic characteristics of the solid surfactants present are sufficiently pronounced, it is preferred that less than 90%, advantageously less than 70%, preferably less than 50% of the surface of the particles should be involved in the complexing of the chains with predominantly hydrophobic characteristics.

For this reason, according to the this first variant the rate of coverage of the surface of the particles expressed, for each particle, by the ratio of the number of hydrophilic heads complexed on the surface of the said particle to the total surface area of this particle is specifically less than 4 heads per nm².

It is preferred, moreover, that at least 2%, advantageously more than 10%, preferably more than 20% of the surface of the particles should be involved in the complexing of the chains with predominantly hydrophobic characteristics.

Therefore the rate of coverage of the particles present is generally between 0.4 and 3.2 hydrophilic heads per nm², and preferably between 1 and 3.2 hydrophilic heads per nm².

Moreover, it should be noted that, especially so as to ensure optimal (molecular surfactant)-particle complexing, it is generally preferred according to this first variant to use charged particles and molecular surfactants of the ionic type of opposite charge. Advantageously the charged particles are, if appropriate, particles with a positive charge. The ionic group inducing the complexing bond is then an anionic group. This anionic group is preferably chosen from amongst the carboxylate, phosphate, phosphonate, ester phosphate, sulphate, sulphonate or sulphosuccinate groups. The organic chain(s) with hydrophobic characteristics used in this case are alkyl chains, ethoxylated or non-ethoxylated, comprising from 8 to 30 carbon atoms and from 0 to 10 ethoxyl groups. It is equally possible to use amphoteric surfactant molecules such as amine propionates, alkyldimethylbetaines, imidazoline derivatives, alkylamidobetaines, or also alkylglycines.

However, the use of negatively charged particles complexed by molecular surfactants of the cationic or amphoteric type is not excluded from the subject of the invention.

According to a second variant, the bonds between the organic chains and the surface of the particles present are covalent bonds. In this case, these covalent bonds are generally established between metal atoms of the particles and the organic chains, via oxygen atoms initially present in a hydroxylated metal group on the surface of the particles.

The metal atom of these hydroxylated metal surface atoms is preferably a silicon, aluminium or titanium atom. In this case the particles present are formed at least partially of silicon oxide, aluminium oxyhydroxide and/or titanium oxide, this or these oxide(s) and/or oxyhydroxide being at least present at the surface. Thus the particles can then in particular be formed of oxide (s), hydroxide(s) and/or oxyhydroxide(s) of variable chemical nature, having a surface layer of silicon oxide, aluminium oxyhydroxide and/or titanium oxide, produced for example by surface post-treatment.

According to this second variant of the invention, the organic chains bonded in a covalent manner are generally introduced by condensation of a silanol-SiOH group on the particle according to the general reaction:

[particle]-M—OH+HO—Si [organic chain]♦[particle]-M—O—Si—[organic chain],

where M represents Si, Al or Ti.

In this case the silanol-SiOH group generally originates from the acid, neutral or basic hydrolysis of an alkoxysilane group, for example from the acid hydrolysis of a compound of the trimethoxyalkylsilane or trietboxyalkylsilane type.

Regardless of the nature of the metal atom involved, it should be noted that the covalent bond used and the methods employed in order to establish it must not be of a nature to nullify or to reduce too much the hydrophilic nature of the surface of the particles present. More precisely, it is preferred according to this particular variant of the invention that the rate of coverage of the surface of the particles present, expressed individually by the ratio of the number of bonds established on a particle relative to the total surface area of that particle, should be between 0.4 and 3.2 bonds per nm², and preferably between 1 and 3.2 bonds per nm².

Moreover, the chains with predominantly hydrophobic characteristics which are used when the bond is of a covalent nature are generally alkyl chains comprising from 6 to 30 carbon atoms, and preferably from 8 to 18 carbon atoms.

Although the two types of chain-particle bonds described above constitute two particularly advantageous variants of the invention, it should be emphasised that the scope of the invention should not be limited to these two particular variants where the bonds between hydrophobic chains and particles are ensured either by complexing bond or by covalent bond.

Thus the bonds ensured between the surface of the particle and the hydrophobic chains present can in particular be of a different nature within one and the same surfactant of solid type according to the invention. Thus for example hydrophobic chains bonded in a less significant manner to the surface, particularly by electrostatic bonds or by hydrogen bonds, can coexist alongside chains fixed by covalent and/or complexing bonding.

Regardless of the exact nature of the bonds used in order to ensure the cohesion between the chains with hydrophobic characteristics and the surface of the particles, it is preferred that the connections between the chains with hydrophobic characteristics and the particles present within the compositions according to the invention should be distributed in an inhomogeneous manner over the surface of the said particle, in such a way as to define a first zone with substantially hydrophilic characteristics and a second zone with substantially hydrophobic characteristics.

Thus, in a particularly advantageous manner, the surface-modified particles present in the compositions according to the invention are such that they can each be divided by a cross-sectional plane into two surfaces S₁ and S₂ such that:

(i) each of the surfaces S₁ and S₂ represents at least 20% of the total surface of the particle; and

(ii) the density per unit area of organic chains bonded at S₂ is greater than at least 5 times the density per unit area of chains with hydrophobic characteristics bonded at S₁.

Regardless of the exact structure of the particles which they contain, the compositions according to the invention specifically have pronounced emulsifying characteristics. These marked emulsifying characteristics may be demonstrated by the fact that they are capable of emulsifying water/oil systems in the form of stabilised emulsions having a high aqueous phase content and a small average drop size.

Thus the compositions according to the invention are generally capable of emulsifying water/oil systems in the form of stabilised inverse emulsions, and they can in particular be used within this framework in order to form emulsions of the water-in-vegetable-oil type or the water-in-silicone-oil type with a high content of dispersed aqueous phase, that is to say having specifically an aqueous phase content at least equal to 40%, advantageously greater than or equal to 50%, even greater than or equal to 60% in certain cases.

The use of the compositions according to the invention for the emulsification of such water/oil systems in the form of inverse emulsions makes it possible, subject to the emulsification conditions being sufficiently advanced, to obtain average drop sizes smaller than or equal to 5 microns for these stabilised inverse emulsions. Surprisingly, since average drop sizes of the order of 5 microns are generally difficult to achieve with the usual emulsifying compositions, the compositions according to the invention make it possible in certain cases to obtain sizes smaller than or equal to 3 microns, advantageously smaller than 2 microns and, particularly advantageously, of the order of one micron.

Moreover, the emulsifying compositions according to the invention generally make it possible to emulsify water/oil systems in the form of stabilised direct (oil-in-water) emulsions having a dispersed phase content which can be greater than 40%, preferably greater than 50%, indeed greater than 60% or even greater than 70%. Subject to the emulsification conditions being sufficiently advanced, the size of the drops present within the direct emulsions obtained using the emulsifying compositions according to the invention is generally smaller than or equal to 3 microns, advantageously it can be smaller than or equal to 2 microns, and preferably smaller than or equal to 1 micron.

The emulsifying compositions according to the invention can be based on several types of particles of nanometre dimensions and/or chains with hydrophobic characteristics. For this reason they can for example comprise one single type of solid surfactant such as was defined previously, but they can equally comprise a mixture of several types of these solid surfactants, and in particular solid surfactants having different lengths and/or natures of the predominantly hydrophobic chains, or even a mixture of solid surfactants based on solid particles of different chemical natures. Within the framework of this type of mixture, it is generally usual to avoid the association within one and the same composition of surfactants formed from solid particles having charges per unit area with opposing signs, but such an association is not, however, excluded from the scope of the present invention.

Depending upon the exact nature of the solid particle and of the chains with hydrophobic characteristics which are used, the emulsifying compositions according to the present invention can be formulated in various ways.

However, taking account of the specificity of the solid surfactants according to the present invention, the emulsifying compositions comprising these surface-modified particles are advantageously present in the general case in the form of an emulsion of the oil-in-water or water-in-oil type, wherein the said particles of nanometre dimensions, on the surface of which the organic chains with hydrophobic characteristics are bonded, are at least partially located at the interfaces of the water/oil type of the said emulsion. Thus these can be emulsions stabilised by solid surfactants according to the invention.

These emulsions of the oil-in-water or water-in-oil type preferably have a percentage of dispersed phase relative to the continuous phase of between 2 and 45% by volume, advantageously between 8 and 30% by volume, and particularly preferably between 10 and 25% by volume.

The average size of the drops present within the emulsifying compositions according to the invention in the form of emulsions is generally between 0.1 μm and 10 μm, and preferably between 0.5 μm and 3 μm, with a homodisperse or polydisperse distribution of these drops.

The concentration of solid surface-modified particles within this emulsion can for its part be characterised by a rate of coverage of the drops of the emulsion. This rate of coverage is defined by the ratio of the portion of the total surface area of the drops occupied by the particles relative to the total surface area developed by the drops of the emulsion. Advantageously this rate of coverage of the drops of the emulsion is between 20% and 100%. It is preferably greater than 50%, and particularly preferably greater than 80%.

Moreover, it should be noted that in addition to the particles of the solid surfactant type which ensure the stabilisation at the liquid/liquid interfaces, the emulsifying compositions according to the invention which take the form of emulsions can also contain surface-modified particles not present at these interfaces, and particularly at interfaces of the water/air or oil/air type.

Overall, taking account of the totality of the surface-modified particles present within the emulsion, it is possible to define a theoretical rate of incorporation of the particles, defined by the ratio of the total surface area which the solid particles present within the emulsion are theoretically capable of covering relative to the theoretical total surface area developed by the drops of the emulsion. For this calculation of the theoretical total surface area developed by the drops of the emulsion, it is assumed that the emulsion has a monodisperse distribution, with a drop diameter equal to the average diameter of the drops present. Taking account of this definition, this theoretical rate can be greater than 100%. The concentration of surface-modified particles within the emulsion is preferably such that this theoretical rate of incorporation is between 20% and 300% and advantageously between 50% and 200%.

The presence of these surface-modified particles at the liquid/liquid interfaces permits effective stabilisation of the emulsifying composition in the form of an emulsion. In a general manner, the stability obtained is such that centrifugation greater than or equal to 4000 r.p.m. is not capable of destabilising the emulsion obtained.

Moreover, this stabilised emulsion is specifically a stabilising composition which can be used in order to ensure the stabilisation of emulsions of the oil-in-water or water-in-oil type. However, taking account of the dilution introduced into this type of operation, these emulsifying compositions in the form of emulsions are, in this case, generally used in high proportions, usually in a quantity of 10% to 80% by volume relative to the total volume of the emulsion to be stabilised, and advantageous in a quantity of 10% to 50% by volume.

For this reason, when it is possible it is preferred to use the solid surfactants according to the invention in the form of a concentrated formulation preferably having a solids content greater than 5% by mass, advantageously greater than 8% by mass, and preferably greater than 10% by mass.

This concentrated formulation can for example be formed by an ultracentrifugation residue obtained for example by ultracentrifugation, or also by concentration by slow evaporation, of an emulsifying composition in the form of an emulsion as defined previously.

However, it should be emphasised that this type of formulation cannot be envisaged with all the types of surface-modified particles according to the invention. In fact, within this type of concentrated formulation the solid particles are sufficiently close together to enable phenomena of inter-particle agglomeration to be observed.

For this reason the surface-modified particles used in this type of concentrated formulation are preferably based on solid particles of cerium oxide, titanium oxide and/or aluminium oxyhydroxide, preferably having high charges per unit area, for which these phenomena of reagglomeration are minimised. However, the concentrated emulsifying formulations according to the invention cannot be limited to these particular compounds.

In addition to these surface-modified particles, the emulsifying compositions according to the invention in the form of concentrated formulations generally contain water and liquid compounds which are only slightly or not miscible in water such as vegetable oils, silicone oils or hydrocarbons. The ratio of the water content and the content of hydrophobic liquid compounds in these compositions is variable within a wide range.

Thus in the case of a concentrated formulation obtained by ultracentrifugation of an emulsion, this ratio varies as a function of the nature of the mother emulsion. Generally the ratio per unit volume of the phase corresponding initially to the dispersed phase relative to the phase corresponding initially to the continuous phase of the mother emulsion is between 0.01 and 0.5 Advantageously this ratio per unit volume is between 0.01 and 0.25, and preferably between 0.01 and 0.1.

The concentrated formulations defined above have significant emulsifying properties. They are capable of stabilising emulsions of the water-in oil or oil-in water type, even multiple emulsions with a good stability over time. In a general manner, this type of concentrated emulsifying composition is used in a proportion of 10 to 200% by mass relative to the mass of the dispersed phase of the emulsion to be stabilised. These formulations are advantageously used in a proportion of 10 to 100% by mass and preferably a proportion of 10 to 50% by mass relative to the mass of the dispersed phase.

The emulsifying compositions comprising surface-modified particles according to the invention can also be present in the form of dispersions with a high solids content having, as the case may be, solids content of between 10 and 90% by mass.

These concentrated dispersions are generally formed by a dispersion of surface-modified particles according to the invention in a continuous phase with hydrophilic or hydrophobic characteristics, where the said continuous phase generally represents at least 50% of the volume of the dispersion.

The stabilised emulsions obtained by using the emulsifying compositions according to the invention, regardless of whether they are in the form of emulsions of concentrated formulations or of a dispersion with a high solids content, can use numerous compounds by way of the hydrophobic phase, such as vegetable oils, mineral oils, aromatic solvents or even non-hydrosoluble ketones.

The nature of the hydrophobic and hydrophilic phases used within the stabilised emulsions by the use of an emulsifying composition according to the invention is not forcibly subordinated to the nature of the hydrophilic and hydrophobic phases present within the emulsifying composition. Thus an emulsifying composition comprising a particular hydrophobic phase could in particular be used in order to ensure the stabilisation of an emulsion comprising another type of oil, in so far as this oil is soluble in the one present in the emulsifying composition.

Finally, in the case of the use of certain particles, the emulsifying compositions according to the invention may be present in the form of a solid powder.

According to another aspect, the present invention also relates to a method of preparation of emulsifying compositions such as have been defined previously.

This method of preparation of an emulsifying composition according to the invention is characterised in that it comprises a step consisting of forming an emulsion from an aqueous phase and a hydrophobic phase in the presence of a molecular surfactant and of colloidal particles of metal oxide, hydroxide and/or oxyhydroxide of nanometre dimensions having a hydrophilic surface and advantageously having a non-zero surface charge.

Moreover, this step of formation of the emulsion must be specifically carried out in such a way as to cause the colloidal particles associated with the molecular surfactants to be anchored at the water/oil interfaces of the emulsion whilst avoiding the transfer of these colloidal particles associated with the molecular surfactant towards the hydrophobic phase. This anchoring induces for the particles a zone orientated towards the hydrophobic phase and a zone orientated towards the hydrophilic phase.

The specific anchoring of the particles to the interfaces which is achieved in this way can be viewed for example by transmission cryomicroscopy on frozen specimens using the Dubochet method, which consists of producing a thin film with a thickness of between 50 and 100 nm by dipping a pierced support into the emulsion, and dipping the film thus obtained into liquid ethane or liquid nitrogen, which preserves a state of dispersion of the particles which is representative of that present in the initial emulsion.

Depending upon the exact nature of the interactions existing between the particles and the molecular surfactants used, two illustrative examples are produced:

Case 1:

The interactions between the particles and the molecular surfactants are strong complexing bonds. In this case the particles anchored at the interfaces are solid surfactants within the sense of the invention and the emulsion obtained is an emulsifying composition within the sense of the invention. In fact, the fixing of the molecular surfactants by complexing action on the surface of the particle is preferably orientated in the direction of the hydrophobic phase, which gives the particles obtained effective amphiphilic characteristics.

Case 2:

The interactions between the particles and the molecular surfactants are sufficiently weak to enable the surfactants associated with the particles to be eliminated easily. In this second case the method according to the invention comprises a second step of fixing the chains by covalent bonding on the surface of the anchored particles orientated in this way, and a third step of eliminating the molecular surfactants used initially, whereby an emulsifying composition according to the invention is obtained.

Thus according to a first embodiment, the method of preparation of an emulsifying composition according to the invention comprises the steps consisting of:

a) forming a hydrophobic phase and an aqueous dispersion of colloidal particles of metal oxide, hydroxide and/or oxyhydroxide of nanometre dimensions having a hydrophilic surface, the said hydrophobic phase or the said aqueous dispersion comprising a molecular surfactant capable of being associated with the colloidal particles by complexing;

b) producing a mixture by addition of the hydrophobic phase to the aqueous dispersion or by addition of the aqueous dispersion in the said hydrophobic phase; and

c) subjecting the mixture obtained to emulsification.

The hydrophobic phase used in this first embodiment of the method consists of a liquid or a mixture of organic liquids at least slightly soluble in water, and advantageously insoluble in water, which can be of an extremely varied nature.

Thus this could in particular be an inert aliphatic and/or cycloaliphatic hydrocarbon, or a mixture of such compounds, such as for example a mineral oil or a petroleum spirit which may, as the case may be, contain aromatic compounds. As an indication, hexane, heptane, octane, nonane, decane, cyclohexane, cyclopentane, cycloheptane and liquid naphthenes may be mentioned as compounds which are particularly suitable. Aromatic solvents such as benzene, toluene, ethylbenzene and xylenes are also suitable, as well as petroleum fractions of the ISOPAR or SOLVESSO type (registered trade marks of EXXON), particularly SOLVESSO 100, which essentially contains a mixture of methylethylbenzene and trimethylbenzene, and SOLVESSO 150, which contains a mixture of alkyl benzenes, particularly of dimethylethylbenzene and tetramethylbenzene.

It is also possible to use chlorinated hydrocarbons such as chlorobenzene or dichlorobenzene, chlorotoluene, as well as aliphatic and cycloaliphatic ethers such as diisopropyl ether, dibutyl ether, or aliphatic and cycloaliphatic ketones such as methylisobutylketone, dibutylketone, or even mesityl oxide.

Water-immiscible ketones can also be used.

Esters can also be envisaged. Examples of esters which can be used are in particular those resulting from the reaction of acids with alcohols having from 1 to 8 carbon atoms, and particularly palmitates of secondary alcohol such as isopropanol. The acids from which these esters are produced can be aliphatic carboxylic acids, aliphatic sulphonic acids, aliphatic phosphonic acids, alkylarylsulphonic acids, and alkylarylphosphonic acids having from approximately 10 to approximately 40 carbon atoms, either natural or synthetic. Examples are the fatty acids of tall oil, coconut oil, soya oil, tallow oil, linseed oil, oleic acid, linoleic acid, stearic acid and its isomers, pelargonic acid, capric acid, lauric acid, myristic acid, dodecylbenzenesulphonic acid, 2-ethyl hexanoic acid, naphthenic acid, hexoic acid, toluenesulphonic acid, toluenephosphonic acid, laurylsulphonic acid, laurylphosphonic acid, palmitylsulphonic acid and palmitylphosphonic acid. The mixtures of these different compounds, and particularly the vegetable oils, are particularly suitable hydrophobic phases.

Silicone oils are also hydrophobic compounds which are advantageously used.

Nevertheless, it should be noted that the exact nature of the hydrophobic phase used in the process should be adapted according to the nature of the molecular surfactant used. In fact it should in particular be emphasised that in this first embodiment of the process the affinity between the hydrophobic phase and the molecular surfactant used must be sufficiently weak to permit observation of the anchoring of the particles to the interfaces of the emulsion produced.

In other words, the hydrophobic phase and the molecular ionic surfactant which are used in this first embodiment of the process are generally chosen in such a way that the said molecular surfactant does not lead, in the absence of colloidal particles, to an optimal emulsion, particularly in terms of stability, of a hydrophilic phase with the hydrophobic phase used.

In a general manner, the hydrophobic phase and the hydrophobic chain of the molecular ionic surfactant used are chosen in such a way that the said hydrophobic phase has a poor compatibility with the hydrophobic chain of the molecular surfactant used. In so far as the choice of the hydrophobic phase and of the molecular surfactant is concerned, the person skilled in the art will therefore be able to use the concept based on the parameters of volume and solubility.

In fact, a hydrophobic phase can be characterised by three solubility parameters δD, δP and δH, defined from the cohesive energy corresponding to the intermolecular forces of attraction. δD, δP and δH represent respectively the parameters corresponding to the London dispersion energy, the Keesom energy of polarity and a parameter linked to the hydrogen bonding forces. On this subject reference may be made in particular to the article by J. Hidelbrand in the Journal of the American Chemical Society, volume 38, page 1452 (1916)or to the work by J. Hidelbrand et al, “The solubility of non electrolytes”, 3^{rd} edition, Reinhold, N.Y. (1949).

In general terms, a hydrophobic chain will be all the less soluble in a hydrophobic phase as the solubility parameters δD, δP and δH of this chain are different from those of the hydrophobic phase.

Thus, in the case of the use of a molecular surfactant comprising an ethoxylated alkyl chain by way of a hydrophobic chain, the hydrophobic phase used is preferably a vegetable oil such as a soya oil, a rapeseed oil, a coconut oil or a linseed oil.

In the case of the use of a molecular surfactant comprising a non-ethoxylated alkyl chain by way of a hydrophobic chain, the hydrophobic phase is advantageously a silicone oil such as for example a silicone oil chosen from amongst the silicone oils sold by Rhodia under the name of Rhodorsil.

The nature of the molecular surfactant used is for its part to be adapted according to the nature of the emulsion (direct or inverse) envisaged and the nature (size, composition, . . . ) of the particles used. However, in the general case the molecular surfactants used generally have a molecular mass of 100 g/mol to 10 000 g/mol, and advantageously 100 g/mol and 5 000 g/mol. These molecular surfactants can for example be surfactants of the sequenced oligomer or copolymer type.

Moreover, the molecular surfactants used have specifically a chemical group capable of complexing the metal cations present on the surface of the particles used.

In fact, the aim of the process according to this first embodiment is specifically to formulate an emulsifying composition comprising solid surfactants in the sense of the invention where fixing of the hydrophobic chains on the surface of a particle is ensured by strong complexing.

Thus in the general case, particularly in such a way as to ensure optimal cohesion between the particle and the molecular surfactant within the emulsifying composition obtained, the molecular surfactants used according to this first embodiment are preferably molecular surfactants with a complexing polar head which can for example be surfactants with a carboxylic acid or carboxylate polar head, surfactants with a phosphoric acid or phosphate polar head, surfactants with a sulphosuccinic acid or sulphosuccinate polar head, or surfactants with a sulphonic acid or sulphonate polar head.

These surfactants could advantageously be chosen from amongst the alkylcarboxylates or carboxyl acids having from 6 to 18 carbon atoms or the alkylphosphates having from 6 to 18 carbon atoms. These molecular surfactants can equally be chosen from amongst the polyethylene alkyl ethers of carboxyl acids of formula Rₐ—(OC₂H₄)ₙ—O—R_{b}, where Rₐ is a linear or branched alkyl having from 4 to 20 carbon atoms, n is a whole number between 1 and 12 and R_{b} is a carboxylic acid group such as CG₂—COOH, or the mixtures of such compounds, such as those sold under the trademark AKIPO® by Kao Chemicals.

The molecular surfactant can equally be chosen from amongst the polyoxyethylene phosphate alkyl ethers. “Polyoxyethylene phosphate alkyl ethers” are understood to mean polyoxyethylene alkyl phosphates of formula:

R_{c}—O—(CH₂—CH₂—O)ₙ—O(O)—(OM₁)₂

or also the polyethylene dialkyl phosphates of formula:

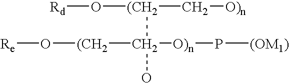

In the above formulae, R_{c}, R_{d}, Rₑ are identical or different and represent a linear or branched alkyl radical having from 2 to 20 carbon atoms; a phenyl radical; an alkylaryl radical, more particularly an alkylphenyl radical, with in particular an alkyl chain having from 8 to 12 carbon atoms; an arylalkyl radical, more particularly a phenylaryl radical; n represents a whole number which can vary from 2 to 12; M₁ represents a hydrogen, sodium or potassium atom. The radicals R_{c}, R_{d} and Rₑ can in particular be hexyl, octyl, decyl, dodecyl, oleyl or nonylphenyl radicals.

Examples which may be given of amphiphilic compounds of this type are those sold under the trademarks Lubrophos® and Rhodafac® by Rhodia, and particularly the following products:

the polyoxyethylene alkyl (C₈-C₁₀) phosphate ethers Rhodafac® RA 600

the tridecyl polyoxyethylene phosphate ether Rhodafac® RS 710 or RS 410

the oleocetyl polyoxyethylene phosphate ether Rhodafac® PA 35

the nonylphenyl polyoxyethylene phosphate ether Rhodafac® PA 17

the nonyl (branched) polyoxyethylene phosphate ether Rhodafac® RE 610

The molecular surfactant can equally be chosen from amongst the dialkylsulphosuccinates, that is to say the compounds of formula R₆—O—C(O)—CH₂—CH(SO₃M₂)—C(O)—R₇ in which R₆ and R₇, which may be identical or different, represent a C₄ to C₁₄ alkyl radical for example and M₂ is an alkaline metal or a hydrogen. Compounds of this type which may be mentioned are those sold under the trademark Aerosol® by Cyanamid. Sequenced polyacrylate-polystyrene copolymers can equally be used, or any sequenced copolymer comprising a hydrophilic part having complexing functions, preferably carboxylates and/or phosphates.

Within the particular framework of the use of cerium oxide or titanium oxide particles, the molecular surfactants used are advantageously surfactants of which the polar head is a complexing group chosen from amongst a carboxylate group or a phosphate group.

In so far as the specific use of aluminium oxyhydroxide AlOOH particles is concerned, the polar head of the molecular surfactant used is preferably a phosphate group.

Moreover, and regardless of the nature of the emulsion and of the molecular surfactant(s) used, the total concentration of molecular ionic surfactant within the hydrophobic or hydrophilic phase is generally such that the quantity of molecular ionic surfactant is used in a quantity of 0.2 to 20% by mass relative to the weight of the dispersed phase of the emulsion obtained, and preferably in a quantity of 0.5 to 10% by mass.

The colloidal particles are advantageously used in this first embodiment of the method in the form of colloidal dispersions which generally have heterodisperse or monodisperse particle size distributions, and preferably monodisperse distributions characterised by an inter-particle agglomeration rate of less then 20% by number, preferably less than 5%, within which the average hydrodynamic diameter of the particles is advantageously between 2 and 100 nm and preferably between 3 and 20 nm. Within these dispersions the particles, which are preferably formed at least partially of an oxide, a hydroxide and/or an oxyhydroxide of a metal chosen from amongst cerium, titanium or aluminium, can have varied chemical groups at the surface, advantageously —OH groups, acetate, nitrate, chloride, acetylacetonate or also citrate groups.

These colloidal dispersions can be produced using various methods which are known to the person skilled in the art, such as high-temperature cracking, followed by an acid peptisation, thermohydrolysis of aqueous solutions, or aqueous precipitations followed by peptisation, described in particular in the patent applications EP-A-208580, FR 99 16876 or FR 99 14728.

Depending upon the properties required for the emulsifying composition obtained in fine, it may be appropriate to choose a hydrophobic phase, a molecular surfactant or specific colloidal particles. Depending upon the choice of a first parameter, for example the chemical nature of the colloidal particle used, it is within the competence of the person skilled in the art to adapt the other parameters, particularly the nature of the hydrophobic phase and of the molecular surfactants used, as well as the different concentrations and the hydrophobic/hydrophilic phase ratio used.

It should be emphasised that these different parameters should be adapted case by case. However, in the general case, the concentration of the colloidal dispersion used is generally such that it corresponds to a theoretical rate of coverage of the drops in the emulsion obtained at the end of step (c), defined by the ratio of the surface which the colloidal particles used are theoretically capable of covering relative to the total surface developed by the drops of the emulsion, between 100 and 600%, preferably between 100 and 400%, and advantageously between 100 and 300%. In other words, therefore, an excess of particles of nanometre dimensions is generally used according to this first method.

For this reason, the concentration of colloidal particles in the colloidal dispersions used is generally between 10²⁰ and 4.10²¹ particles per litre and preferably between 2.10²⁰ and 10²¹ particles per litre.

The ratio of the volume of the dispersed phase to the total volume of the emulsion used according to this first method is, for its part, generally between 5 and 40%, preferably between 10 and 30%, and particularly advantageously between 15 and 25%.

The step (c) leading to the formation of the emulsion from hydrophobic and aqueous phases is generally carried out by dispersion or microfluidisation at ambient temperature, particularly by utilising a rapid disperser of the Ultraturax® type. In this case the emulsion is generally obtained by subjecting the mixture resulting from step (b) to a dispersion under shear, generally carried out for a duration of from 15 seconds to 1 hour, and preferably for a duration of from 30 seconds to 2 minutes, with an agitation speed advantageously between 5 000 and 20 000 r.p.m.

This step (c) of emulsification leads to a so-called “crude” emulsion where, taking account of the preferred use of an excess of colloidal particles, a possibly substantial proportion of the colloidal particles may not be situated at the water/oil interfaces of the emulsion.

For this reason the crude emulsion obtained at the end of step (c) can be subjected to a further step (d) of centrifugation. Should the occasion arise, this centrifugation is carried out at a speed advantageously between 1 000 and 5 000 r.p.m. and for a duration of from 2 minutes to 30 minutes.

Generally this centrifugation leads to 3 phases being obtained: the upper phase of the continuous phase type of the crude emulsion of step (c), the lower phase constituting the residue of centrifugation and generally comprising the colloidal particles used in an excess, and an intermediate phase constituted by a stabilised emulsion of improved quality. It is this stabilised emulsion constituting the intermediate phase which is, should the occasion arise, recovered at the end of step (d).

Whether or not this step of centrifugation is carried out, the emulsion obtained can then be subjected to a step (e) of heat treatment intended to reinforce the interactions between particles and molecular surfactants. This heat treatment step is preferably carried out by bringing the emulsion obtained at the end of the preceding steps to a temperature between 40° C. and 100° C., and preferably between 50° C. and 90° C., for a duration of 30 minutes to 24 hours, and advantageously between 2 hours and 5 hours. During this heat treatment step, the emulsion can be brought to the said temperature either directly or by a progressive rise in temperature ranging, as the case may be, from 4° C. per minute to 0.2° C. per minute.

The emulsion obtained at the end of step (c) and the optional steps (d) and/or (e) can be used by way of emulsifying composition according to the invention. According to a variant of this first mode of preparation, this emulsion can also be subjected in certain cases to a step (f) of ultracentrifugation so as to obtain a concentrated emulsifying formulation in the form of an ultracentrifugation residue. The ultracentrifugation of step (f) is preferably carried out at a rate of 5 000 to 30 000 r.p.m., advantageously at a rate of 3 000 to 25 000 r.p.m., for a duration ranging generally from 1 to 8 hours, and preferably for a duration ranging from 2 to 6 hours.

The ultracentrifugation residue obtained is then generally characterised by a solids content greater than 5% by mass, and preferably greater than 8% by mass. The water and oil contents themselves vary according to the nature of the emulsion subjected to ultracentrifugation. Generally the ratio of the volume of the phase corresponding to the dispersed phase of the original emulsion relative to the volume of the phase corresponding to the continuous phase of the original emulsion varies between 0.01 and 0.5, advantageously between 0.01 and 0.25 and preferably between 0.01 and 0.1.

However, it is important to note that, as has already been emphasised, this step of ultracentrifugation can lead, within the framework of the use of certain colloidal particles, to phenomena of inter-particle agglomerations which are capable of prejudicing the emulsifying properties of the ultracentrifugation residue obtained.

For this reason, the colloidal particles used in this variant of the method are preferably, but not in a limiting manner, particles of oxide, hydroxide or oxyhydroxide of cerium, titanium or aluminium.

The concentrated formulations obtained at the end of step (f) of ultracentrifugation can furthermore be subjected to a step (g) comprising the steps consisting of:

(g₁) adding a solvent to the concentrated formulation, the mass of the added solvent being between 0.1 and 10 times the mass of the concentrated formulation used; and

(g₂) filtering the mixture obtained,

by which a phase enriched with solids is obtained.

This step (g) is advantageously carried out several times with successive solvents of increasing polarities, by which in fine a concentrated dispersion of surface-modified particles of solid surfactant type in an essentially hydrophilic phase is obtained.

In an advantageous manner it is possible during these successive treatments to use first of all solvents with weak polarity such as heptane or hexane, then solvents of more substantial polarity such as chloroform and finally solvents of even stronger polarity such as water-methanol mixtures.

In the same way, the step (g) can be carried out several times with successive solvents of increasing hydrophobicity, by which a concentrated dispersion of surface-modified particles of solid surfactant type in an essentially hydrophobic phase is obtained.

In the course of these different successive steps, a phase enriched with solids can be obtained, in the steps of type (g₂), by filtration, or also by any other means of solid/liquid separation known to the person skilled in the art.

In general, the content of continuous phase in the concentrated dispersion obtained is a minimum of 50% by volume. The solids content for its part is generally between 10% and 90% by mass.

Alternatively, in certain particular cases the emulsion obtained at the end of step (c) and the optional steps (d) and/or (e) can equally be subjected to step (f) of drying at low temperature, that is to say lower than 150° C., by which an emulsifying composition is obtained in the form of a solid. This step (f) is generally carried out at a temperature between 20 and 120° C., and it advantageously includes a step of prior dilution of the emulsion obtained at the end of step (c) and the optional steps (d) and/or (e), by the addition of aqueous phase and/or of hydrophobic phase.

Within this framework, it is generally preferred to use as the hydrophobic phase in the method according to the invention an oil having a low boiling point, advantageously lower than 180° C., preferably lower than 150° C. and even more preferably lower than 120° C. Moreover, the particles of nanometre dimensions used to form the compositions in the form of redispersible solid are generally particles having per se a redispersible nature, such as the particles based on cerium or titanium oxide of the type described in the patent applications FR 99 01939 or FR 99 16786.

The different preferred variants set out above in so far as the first mode of preparation of an emulsifying composition according to the invention are concerned cannot in any case limit this first embodiment to these particular variants.

Thus, subject to adaptation of the nature of the hydrophobic phase and of the molecular surfactant which are used, the majority of the colloidal metal oxide, hydroxide or oxyhydroxide particles of nanometre dimensions can be used in this first embodiment of the method.

More generally, depending upon the exact nature of the colloidal particles of nanometre dimensions which are used and/or the molecular ionic surfactant or the hydrophobic phase used, it is within the competence of the person skilled in the art to adapt steps (a), (b) and (c). The only condition to be met is the formation of an emulsion in the presence of the said particles and of the said molecular surfactant whilst favouring the interactions between particles and molecular surfactants and avoiding the transfer of the particles complexed by the molecular surfactants towards the hydrophobic phase.

According to a second embodiment, the method of preparation of an emulsifying composition according to the invention is characterised in that it comprises the steps consisting of:

(α) forming an emulsion integrating molecular surfactants and colloidal particles of metal oxide, hydroxide or oxyhydroxide of nanometre dimensions and having a non-zero charge per unit surface at the interfaces of the water/oil type;

(β) fixing organic chains with hydrophobic characteristics by covalent bonding on the surface of the said particles thus anchored to the interfaces of the water/oil type by utilising a reagent which is soluble in the continuous phase and comprises an organic chain with at least predominantly hydrophobic characteristics; and

(γ) eliminating at least partially the molecular surfactants present at the end of step (β).

The emulsion of step (α) of this second embodiment of the method can be an emulsion of the oil-in-water or water-in-oil type. When this emulsion is of the oil-in-water type, the aqueous phase is advantageously constituted by a water-ethanol mixture comprising preferably from 20 to 50% of ethanol by volume, this ratio being expressed on the basis of the volumes of water and of alcohol measured before the mixture.

Regardless of the exact nature of the emulsion, the volume of the dispersed phase generally represents from 5 to 50%, and preferably from 10 to 40%, relative to the total volume of the emulsion.

The hydrophobic phase of the emulsion of step (α) can for its part be constituted in a general manner by one of several organic liquids which are not or only slightly soluble in water, such as those used according to the first method.

However, this hydrophobic phase is preferably constituted at least partially by a mixture of aliphatic hydrocarbons preferably having from 8 to 18 carbon atoms. Thus the hydrophobic phase can advantageously be a petroleum fraction of the type of ISOPAR petroleum fractions sold by Exxon (aliphatic C₁₂-C₁₄ petroleum fractions).

Regardless of the nature of its constituents, the emulsion of step (α) is above all characterised by the presence of molecular surfactants. These molecular surfactants perform the role of transitory emulsifying agents and are generally used in a quantity of 0.5 to 10% by mass relative to the mass of the dispersed phase.

Moreover, particularly in order to ensure an optimal emulsifying role, these molecular surfactants performing the role of transitory emulsifying agents are preferably used in the form of the association of at least one molecular surfactant of the nonionic type and at least one molecular surfactant of the ionic type. Moreover, it should equally be noted that these molecular surfactants must be chosen in such a way that they can be eliminated relatively easily during the later step (γ).

For this reason, the molecular nonionic surfactant(s) used are, as the case may be, preferably ethoxylated alcohols comprising from 2 to 10 ethoxyl groups and from 8 to 18 carbon atoms at the level of their alkyl chain, such as those sold under the brand names Brij 30, Brij 35, Brij 52, Brij 56, Brij 58, Brij 76, or Brij 78, by Fluka, or also the surfactants sold by Sigma under the brand name Tergitol, the nonionic surfactants with a sorbitan head, or also the surfactants sold under the name Span by Fluka.

The molecular ionic surfactant(s) used depend for their part at least partially upon the nature of the particles used.

Thus in the case of particles with a negative surface charge, the molecular ionic surfactants used are preferably mono-, di- or trialkylamines in their protonated form.

In the case of particles with a positive surface charge, the molecular ionic surfactants are generally surfactants with a carboxylate polar head, advantageously alkylethoxyl carboxylates comprising from 2 to 10 ethoxyl groups and from 8 to 18 carbon atoms at the level of their alkyl chain.

In this case the molar ratio (ionic surfactants)/(ionic and nonionic surfactants) is generally between 5 and 50%, preferably between 10 and 30%.

In a preferred but non-limiting manner, the colloidal particles of nanometre dimensions which are used according to the second embodiment of the method according to the invention are colloidal particles which comprise at least on the surface, a silicon oxide, an aluminium oxyhydroxide or a titanium oxide. Thus it will be possible in particular to use the colloidal particles sold under the brand name Ludox® by Dupont de Nemours. Regardless of their chemical nature, these particles are preferably used in the form of a colloidal dispersion in an aqueous or hydro-alcoholic medium within which the average hydrodynamic diameter of the particles is generally between 2 and 50 nm, and preferably between 3 and 40 nm. The concentration of colloidal particles within this dispersion is advantageously between 10²¹ and 4.10²¹ particles per litre, and preferably between 10²¹ and 4.10²¹ particles per litre.

Moreover, these aqueous colloidal dispersions preferably have either a clearly acid pH, generally lower than 3, and advantageously lower than 2, or a clearly basic pH, generally higher than 8, and preferably higher than 8.5.

The aim of step (α) is specifically to obtain an emulsion where the particles of nanometre dimensions and having a non-zero surface charge are anchored to the interfaces of the water/oil type. This arrangement of the particles induces schematically for each of the particles located in this way a zone which is orientated towards the hydrophobic phase and a zone which is orientated towards the hydrophilic phase.

The fixing of the chains with at least predominantly hydrophobic characteristics on the surface by the use in step (β) of a reagent which is soluble in the continuous phase leads to preferential fixing at the level of the zone orientated towards the continuous phase.

The fixing of the chains with predominantly hydrophobic characteristics by covalent bonding carried out during the course of step (β) is advantageously effected by condensation of a silanol on the surface of the particle. In this case the reagent used is a silane which, by hydrolysis on contact with the aqueous phase, forms the corresponding silanol.

For this reason, in the case of the use of a silane the hydrophilic phase used in the emulsion of step (α) is advantageously an aqueous or hydro-alcoholic phase with a pH lower than 3 or higher than 8, in such a way as to ensure an acidic or basic hydrolysis of the silane used.

The condensation reaction of the silanol on the surface of the particle is produced by progressive addition of a silane into the emulsion, whilst stirring, at a temperature ranging from 15° C. to 95° C., and preferably from 25° C. to 80° C., and preferably in the form of a solution in a hydrophobic solvent, advantageously in a solution in a solvent of the hydrophobic phase type use in the emulsion.

The silane used is preferably a compound of formula R—Si(OR′)₃, where OR′ designates a group chosen from amongst the methoxy or ethoxy groups, and R designates an ethoxylated alkyl chain R⁴—(CH₂—CH₂—O)ₙ, where R⁴ represents a linear or branched alkyl chain comprising from 8 to 30 carbon atoms, and n represents a whole number ranging from 1 to 10.

Regardless of the nature of the reagent soluble in the continuous phase used in step (β), the quantity of the said reagent used depends upon the rate of coverage of the particle required in fine.

Moreover, it should equally be noted that this quantity is to be adapted as a function of the physico-chemical nature (size, surface, composition) of the colloidal particles used and the nature of the reagent.

Thus in the case of the specific use of a silane the quantity used, expressed relative to the total surface of the particles used in step (β), is generally between 0.1 and 10 molecules of silane per nm². This quantity is generally added progressively, advantageously at a constant rate and for a duration ranging from 5 minutes to 6 hours and preferably between 15 minutes and 2 hours.

The addition is generally followed by maturing, advantageously for a duration ranging from 2 to 16 hours, and preferably at a temperature ranging from 15° C. to 25° C.

The emulsion obtained at the end of step (β) contains molecular surfactants and possible excess reagents which it is necessary to eliminate at least partially so as to obtain an emulsifying composition according to the invention.

In order to do this, the step (γ) of elimination of the molecular surfactants playing the role of transitory emulsifying agents generally includes at least one centrifugation step, generally carried out at the rate of 500 to 5 000 r.p.m. for a duration ranging from 3 to 60 minutes. Should this be the case, the centrifugation carried out generally leads to a phase being obtained with a high solids content.

Several successive centrifugations are advantageously carried out. In this case, the phase with a high solids content which is obtained at the end of each centrifugation step is generally washed by redispersion in a mixture of the water/oil type, advantageously comprising the same hydrophobic phase as that used in the emulsion of step (α). The pH of the aqueous phase of the washing mixture of the water/oil type which is used is preferably modified in such a way as to obtain the neutral form of the molecular ionic surfactant to be eliminated. Thus in the case of the use of an anionic molecular surfactant the aqueous phase will advantageously be acidified, for example by the addition of a strong acid such as HCl or HNO₃. In the case of the use of a cationic molecular surfactant, a base such as ammonia will advantageously be added to the aqueous phase. The choice of the base or the acid which is used in this case should naturally be adapted as a function of the nature of the solid particles specifically used, particularly so as to avoid their degradation.

However, it should be noted that the last washing stage is generally in a mixture of the water/oil type with a neutral pH.

Thus the steps (α), (β) and (γ) of this second embodiment of the method generally lead to the formation of emulsifying compositions in the form of emulsions which are more concentrated than those obtained at the end of steps (c), (d) and/or (e) of the first method.

For this reason, the emulsion obtained at the end of step (α) can be used as an emulsifying composition according to the invention.

However, this emulsion can equally be subjected in certain cases to a subsequent step (δ) of ultracentrifugation so as to obtain a concentrated emulsifying formulation in the form of an ultracentrifugation residue. The ultracentrifugation of step (δ) is then preferably carried out at a rate of 5 000 to 25 000 r.p.m., advantageously at a rate of 3 000 to 20 000 r.p.m., for a duration generally ranging from 1 to 8 hours, and preferably for a duration ranging from 2 to 5 hours.

The ultracentrifugation residue obtained is then generally characterised by a solids content higher than 5% by mass. The contents of water and of oil for their part vary as a function of the nature of the emulsion resulting from step (α). In general terms, the ratio of the volume of the phase corresponding to the dispersed phase of the original emulsion relative to the volume of the phase corresponding to the continuous phase of the original emulsion varies between 0.01 and 0.5.

The concentrated formulations obtained at the end of the ultracentrifugation step (δ) can advantageously be subjected to a step (ε) comprising the steps consisting of:

(ε₁) adding a solvent to the concentrated formulation, the mass of the solvent added being between 0.1 and 10 times the mass of the concentrated formulation used; and

(ε₂) filtering the mixture obtained, by which a phase enriched with solids is obtained.

This step (ε) is advantageously carried out several times with successive solvents of increasing polarity, by which a concentrated dispersion of surface-modified particles of the solid surfactant type in an essentially hydrophilic phase is obtained.

The step (ε) can equally be carried out several times with successive solvents of increasing hydrophobicity, by which a concentrated dispersion of surface-modified particles of solid surfactant type in an essentially hydrophobic phase is obtained.

In general, the content of continuous phase in the concentrated dispersions obtained is greater than 50% by volume. The solids content for its part is generally between 10% and 80% by mass.

Due to their emulsifying characteristics and the presence of solid particles within their composition, and regardless of the manner by which they are obtained and the exact nature of their constituents, the emulsifying compositions according to the invention can be used in numerous spheres of application.

Thus the emulsifying compositions according to the invention can in particular be used for the formulation of detergent compositions particularly adapted to the cleaning of hard surfaces, where the association of the emulsifying characteristics and the presence of solid particles produces simultaneously a mechanical abrasion and an emulsification of hydrophobic stains.

Moreover, the emulsifying compositions according to the invention can present interesting physico-chemical properties due to the presence of the solid particles.

For this reason, the emulsifying compositions according to the invention can in particular be used for the manufacture of films and of materials, particularly packaging films, having anti-UV or anti-corrosion properties, for example by the use of particles based on cerium oxide the use of the solid particles with amphiphilic characteristics can equally permit the manufacture of films with a high mechanical resistance, or also of opacifying films, for example using particles based on titanium oxide.

In this type of material, the solid particle with amphiphilic characteristics originating from the emulsifying composition simultaneously plays a role linked to its intrinsic physico-chemical properties and a role as surfactant linked to its amphiphilic characteristics. By comparison with the molecular surfactants conventionally used in the constitution of such materials, the surface-modified particles of the surfactant type according to the invention also have the interesting feature, due to their solid character, that they do not lead to the phenomena of surface migration which are generally observed.

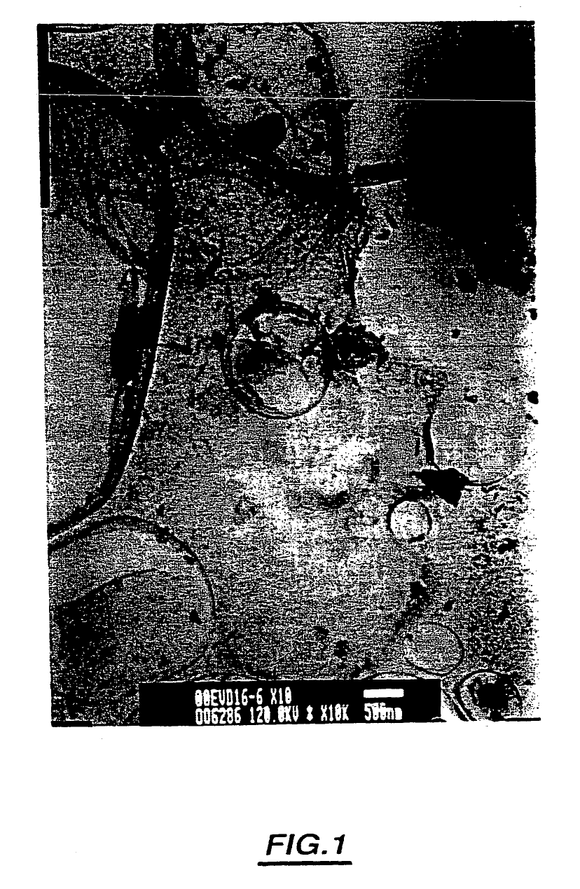

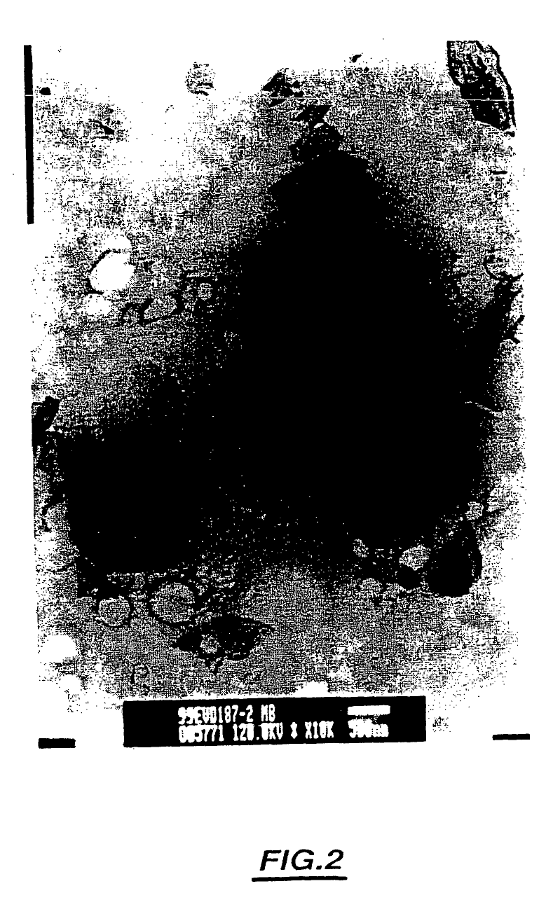

The accompanying FIGS. 1 and 2 are photographs obtained by subjecting emulsifying compositions according to the invention in the form of emulsions to an analysis by transmission electron cryomicroscopy.

FIG. 1 is a photograph obtained by cryomicroscopy of an emulsion characterised by the following elements:

dispersed phase: water

continuous phase: silicone oil MIRASIL DM 50 (RHODIA)

solid particles with amphiphilic characteristics: particles of cerium oxide CeO₂ surface-modified by the presence of caprylates.

FIG. 2 is likewise a photograph obtained by cryomicroscopy of an emulsion characterised for its part by the following elements:

dispersed phase: water

continuous phase: rapeseed oil (Prolabo)

solid particles with amphiphilic characteristics: particles of cerium oxide CeO₂ surface-modified by the presence of Akipo RO 20 V6 (KaO Chemicals GmbH).

The illustrative examples set out below concern the preparation of emulsifying compositions comprising solid particles with amphiphilic characteristics according to the invention.

### EXAMPLE 1

Preparation of a Concentrated Emulsifying Composition Comprising Particles of Cerium Oxide with Amphiphilic Characteristics as Surfactants.

(a) 0.4 g of caprylic acid (Prolabo) were added at ambient temperature and whilst stirring to 40 ml of a silicone oil reference MIRASIL DM 50 (Rhodia).

(b) A colloidal aqueous dispersion D of perfectly individual particles of cerium oxide CeO₂ with an average diameter of 5 nm was obtained by redispersion in water of cerium hydrate synthesised as described in the patent application EP 208580 by thermohydrolysis at 100° C. of a solution of partially neutralised ceric nitrate. More precisely, 583.5 g of cerium hydrate at 58.95% CeO₂ were redispersed in demineralised water, the volume being adjusted to 2000 ml. After stirring at ambient temperature, a colloidal dispersion was obtained with a concentration equal to 1.0M of CeO₂. 10 g of the colloidal dispersion of particles of CeO₂ thus obtained were incorporated into the silicone oil phase prepared in step (a).

(c) The mixture thus obtained was then emulsified with the aid of a rapid disperser (Ultraturax) for 2 minutes at a rate of 20 000 r.p.m.

(d) The crude emulsion obtained at the end of step (c) was centrifuged at 4 400 r.p.m. for 10 minutes. Three phases were then collected:

an oily clear and colourless upper phase representing 35% by mass;

a central emulsion representing 48% by mass;

a pasty residue representing 17% by mass.

The central emulsion was recovered.

An examination was carried out by transmission electron cryomicroscopy on an aliquot part of the central emulsion obtained. On the images produced, of which the accompanying FIG. 1 constitutes the most characteristic example, spherical drops are observed which have a higher contrast on the periphery, which confirms the anchoring of the modified particles at the water/silicone oil interfaces within the emulsion. The size distribution of the drops is polydisperse, with sizes of drops varying from 0.5 microns to approximately 6 microns.

(f) Another aliquot part of this emulsion of the central phase was subjected to ultracentrifugation at the rate of 4 g per ultracentrifugation tube. After ultracentrifugation at 20 000 r.p.m. for 3 hours, on average 1.12 g of moist residue were recovered per tube.

The moist residue thus obtained constituted a concentrated emulsifying composition comprising surfactants based on surface-modified solid particles of cerium oxide. The emulsifying properties of this residue were demonstrated by the following test.

3.8 g (that is to say 4 cm³) of silicone oil Mirasil DM 50 were added to 1.35 g of the moist residue obtained. Stirring was carried out manually until a visually homogeneous dispersion was obtained. Then 1 cm³ of demineralised water was added. The mixture obtained was emulsified with the aid of a rapid disperser (Ultraturax) for 2 mn at 20 000 r.p.m.

An emulsion was then obtained of which the size of the drops determined by optical microscopy was of the order of 1 micron.

(g) To another aliquot part of the ultracentrifugation residue obtained at the end of step (f) was added a volume of heptane representing five times the volume of the said aliquot part. The mixture obtained was then stirred at ambient temperature for 30 minutes, then filtered.

The filter cake enriched with solid phase was recovered.

The filter cake obtained was redispersed in a volume of chloroform equal to the volume of heptane of the preceding step.

The mixture obtained was stirred for 30 minutes, then filtered.

The new filter cake was recovered.

The cake recovered was redispersed in a volume of a water/methanol mixture (50:50 by volume) equal to the volume of chloroform of the preceding step.

The mixture obtained was stirred for 30 minutes, then filtered, by which a dispersion with a high solids content was obtained.

The product obtained was then dried at ambient temperature.

Using infrared spectroscopy carried out on the solid product obtained, a peak was demonstrated at 1 510 cm⁻¹. This peak was attributed to the strong carboxylate-cerium (IV) bond used in the sense of the solid particles with amphiphilic characteristics obtained, which corresponds to a bonding energy value clearly higher than a bond of the hydrostatic type or a hydrogen bond.

Moreover, the carbon content of the solid product obtained was 4% by mass relative to the total mass of the solid product.

### EXAMPLE 2

Preparation of an Emulsifying Composition Comprising Particles of Cerium Oxide with Amphiphilic Characteristics as Surfactants.

An emulsion was obtained according to steps (a) to (d) of Example 1. After step (d) of centrifugation at 4 400 r.p.m. and recovery of the central emulsion, the emulsion was subjected to a supplementary step (e) of heat treatment consisting of placing the emulsion in a closed chamber at 80° C. for 5 hours.

Following this heat treatment, a stable emulsion was obtained of which the size of the drops determined by optical microscopy was of the order of 1 micron.

### EXAMPLE 3

Preparation of a Concentrated Emulsifying Composition Comprising Particles of Cerium Oxide with Amphiphilic Characteristics as Surfactants.

(a) 0.6 g of an oleyl ether carboxylic acid sold by KAO Chemicals GmbH under the name Akipo RO 20 VG (mixture of compounds of general formula A—(OC₂H₄)₂—OCH₂COOH, where A represents an alkyl chain having from 16 to 18 carbon atoms) was added at ambient temperature whilst stirring to 40 ml of rapeseed oil (Prolabo).

(b) 10 g of the colloidal dispersion D of particles of CeO₂ of Example 1 were incorporated into the rapeseed oil phase prepared in step (a);

(c) The mixture thus obtained was then emulsified with the aid of a rapid disperser (Ultraturax) for 2 minutes at a rate of 20 000 r.p.m.

(d) The crude emulsion obtained was then centrifuged at 4 400 r.p.m. for 10 minutes. Three phases were collected:

an oily clear and colourless upper phase representing 12% by mass;

a central emulsion representing 73% by mass;

a pasty residue representing 15% by mass.

The central emulsion was recovered.

On an aliquot part of the central emulsion obtained an examination was carried out by transmission electron cryomicroscopy. On the images obtained, of which the accompanying FIG. 2 is an example, spherical drops are observed which have a strong contrast on the periphery, which confirms the anchoring of the modified particles at the water/rapeseed oil interfaces within the emulsion. The size distribution of the drops is polydisperse, with sizes of drops varying from 0.2 microns to 3 microns.

(f) Another aliquot part of this emulsion of the central phase was subjected to ultracentrifugation at the rate of 3.5 g per ultracentrifugation tube. After ultracentrifugation at 10 000 r.p.m. for 3 hours, on average 0.35 g of moist residue were recovered per tube.

The moist residue thus obtained constituted a concentrated emulsifying composition comprising surfactants based on surface-modified solid particles of cerium oxide. The emulsifying properties of this residue were demonstrated by the following test.

3.6 g (that is to say 4 cm³) of rapeseed oil were added to 0.35 g of the moist residue obtained. A dispersion was produced, first of all manually, then by ultrasound. Then 1 cm³ of demineralised water was added. The mixture obtained was emulsified with the aid of a rapid disperser (Ultraturax) for 2 mn at 20 000 r.p.m.

An emulsion was then obtained of which the size of the drops determined by optical microscopy was of the order of 1 micron.

(f) A last aliquot part of the central emulsion obtained at the end of step (d) was subjected to a step of ultracentrifugation at a rate of 3.15 g per ultracentrifugation tube. After ultracentrifugation at 20 000 r.p.m. for 3 hours, on average 0.87 g of moist residue was collected per tube.

After calcination at 900° C., a mass of CeO₂ was determined in the calcined residues corresponding to 9.84% of the mass of the initial moist residue.

### EXAMPLE 4

Preparation of an Emulsifying Composition Comprising Particles of Cerium Oxide with Amphiphilic Characteristics as Surfactants.

An emulsion was obtained according to steps (a) to (d) of Example 3. After step (d) of centrifugation at 4 400 r.p.m. and recovery of the central emulsion, the emulsion obtained was subjected to a supplementary step (e) of heat treatment consisting of placing the emulsion in a closed chamber at 80° C. for 5 hours. Following this thermal treatment, a stable emulsion was obtained of which the size of the drops determined by optical microscopy was of the order of 1 micron.

The stability of the emulsion obtained was such that centrifugation at a rate of 4 400 r.p.m. did not compromise its stability.

### EXAMPLE 5

Preparation of an Emulsifying Composition Comprising Particles of Cerium Oxide with Amphiphilic Characteristics as Surfactants.

(a) 0.6 g of Rhodafac MB sold by RHODIA was added at ambient temperature whilst stirring to 40 ml of rapeseed oil (Prolabo). This anionic surfactant consists of a mixture of monoesters of formula R₁O—(OC₂H₄)₃—PO₃ and of diesters of formula (R₂O—(OC₂H₄)₃)₂(PO₂), where R₁ and R₂ represent alkyl chains having 13 carbon atoms.

(b) 10 g of the colloidal dispersion D of particles of CeO₂ of Example 1 were incorporated into the rapeseed oil phase prepared in step (a).

(c) The mixture thus obtained was then emulsified with the aid of a rapid disperser (Ultraturax) for 2 minutes at a rate of 20 000 r.p.m.

(d) The crude emulsion obtained at the end of step (c) was centrifuged at 4 400 r.p.m. for 10 minutes. Three phases were then collected:

an oily clear and colourless upper phase;

a central emulsion;

a pasty residue.

The central emulsion was recovered.

The stability of this emulsion was such that centrifugation at 4 400 r.p.m. did not compromise its stability.

### EXAMPLE 6

Preparation of an Emulsifying Composition Comprising Particles of Cerium Oxide with Amphiphilic Characteristics as Surfactants.

(a) 0.15 g of Akipo RO 20 VG sold by KAO Chemicals GmbH and defined in Example 3 was added at ambient temperature whilst stirring to 40 ml of rapeseed oil (PROLABO).

(b) Then 10 g of the colloidal dispersion D of particles of CeO₂ of Example 1 were incorporated into the rapeseed oil phase prepared in step (a).

(c) The mixture thus obtained was then emulsified with the aid of a rapid disperser (Ultraturax) for 2 minutes at a rate of 20 000 r.p.m.

At the end of step (c) an emulsion was obtained which had a drop size of the order of 1 micron, although the use of Akipo RO 20 VG used alone as surfactant is not capable of ensuring emulsification of a mixture of the water/rapeseed oil type having a drop size so reduced.

### EXAMPLE 7

Preparation of an Emulsifying Composition Comprising Particles of Cerium Oxide with Amphiphilic Characteristics as Surfactants.

(a) 0.6 g of Akipo RO 20 VG was added at ambient temperature whilst stirring to 40 ml of rapeseed oil (PROLABO).

(b) Then 10 cm³ of a colloidal dispersion of particles of CeO₂ obtained by dilution of 3.49 g of the colloidal dispersion D of particles of CeO₂ of Example 1 by the addition of water until a volume of 10 cm³ was reached were incorporated.

(c) The mixture thus obtained was then emulsified with the aid of a rapid disperser (Ultraturax) for 2 minutes at a rate of 20 000 r.p.m.

An emulsion was then obtained of which the size of the drops, determined by optical microscopy, was of the order of 1 micron.

### EXAMPLE 8

Preparation of an Emulsifying Composition Comprising Particles of Titanium Oxide with Amphiphilic Characteristics as Surfactants.

A colloidal dispersion of titanium oxide TiO₂ was obtained by thermohydrolysis of a solution of TiOCl₂ in the presence of TiO₂ nuclei and citrate anions with a molar ratio citrate/TiO₂ within the dispersion of 3% under the following conditions:

To 394.7 g of a solution of titanium oxychloride at 1.9 mole/kg there were added successively:

42.02 g of hydrochloric acid at 36%;

4.73 g of citric acid;

547.1 g of demineralised water;

73.84 g of a suspension containing 1.06% by mass of anatase nuclei (1.3% TiO₂).

The mixture obtained was brought to boiling and was kept there for 3 hours. The solution was left to decant and the supernatant was drawn off by siphoning.

This supernatant was dispersed in demineralised water in such a way as to obtain a dispersion having a dry extract of 6% by mass. Thus a perfectly stable sol was obtained. The average hydrodynamic diameter of the colloids within this sol was summarised as equal to 22 nm.

(α) 80 ml of Isopar (Exxon), 20 ml of the previously prepared colloidal dispersion of particles of TiO₂ and 1.6 g of Akipo RO 20 VG were added in a beaker. The mixture obtained was emulsified with the aid of a rapid disperser (Ultraturax) for 2 minutes at a rate of 20 000 r.p.m.

(β) To this emulsion, subjected to slow magnetic stirring, 8 g of a solution containing 0.6 g of dodecyl-tri-methoxysilane (sold by Lancaster) in Isopar were added at a constant rate for a duration of one hour. At the end of an hour, the stirring was stopped and the mixture was left to mature at ambient temperature (25° C.) for two hours.

(γ) Centrifugation of the emulsion obtained at the end of the maturing step was then carried out at a rate of 4 500 r.p.m. for 15 minutes. The phase which was rich in solids was recovered and was redispersed in 100 ml of a mixture (HCl 0.5 M:Isopar) (50:50 by volume). This operation was repeated twice. During these operations the phase rich in solids after centrifugation was recovered in the form of a cake at the water-Isopar interface.

The phase enriched with solids obtained at the end of these different washing operations was redispersed in a mixture (water:Isopar) (50:50 by volume) and centrifuged for 15 mn at a rate of 4 500 r.p.m.

60 ml (that is to say 50 g) of an emulsion constituting an intermediate phase between a lower aqueous phase and an upper Isopar phase were then recovered.

This emulsion recovered by centrifugation can be diluted by water.

An aliquot part of this emulsion was ultracentrifuged at 12 000 r.p.m. for 2 hours.

Then:

an upper liquid Isopar phase,

a lower liquid aqueous phase,

a phase enriched with solids at the water-oil interface were recovered.

After mineralisation of the solid obtained by subjecting it to microwaves in the presence of a HF/HNO₃ mixture, a dosage by plasma emission spectrometry indicated a ratio per unit mass Si/Ti of the order of 2%.

The residual concentration of AKIPO RO 20 in the emulsion recovered was also determined by infrared analysis of a solution resulting from the solid/liquid extraction with chloroform. The quantity recovered indicated a very low residual content of the order of 10⁻⁴ moles/litre within the emulsion, which confirms an effective elimination of the surfactant introduced, during the successive washing operations in an acid medium of step (γ).

1. Surfactant formed from at least one particle of nanometre dimensions based on a metal oxide, hydroxide and/or oxyhydroxide, on the surface of which organic chains with hydrophobic characteristics are bonded, the bonds between the said chains and the surface of the said particle being distributed inhomogeneously over the said surface, in such a way that the particle surface-modified in this way has effective amphiphilic characteristics

2. Surfactant as claimed in claim 1, characterised in that the particle used is an isotropic or spherical particle having an average diameter of between 2 and 40 nm.

3. Surfactant as claimed in claim 1 or as claimed in claim 2, characterised in that the said particle is based on an oxide, hydroxide and/or oxyhydroxide of at least one metal chosen from amongst cerium, aluminium, titanium or silicon.

4. Surfactant as claimed in any one of claims 1 to 3, characterised in that the said particle has charged chemical groups on the surface.

5. Surfactant as claimed in any one of claims 1 to 4, characterised in that the organic chains with hydrophobic characteristics bonded to the surface of the particle of nanometre dimensions are alkyl chains comprising from 6 to 30 carbon atoms or polyoxyethylene monoalkyl ethers of which the alkyl chain comprises from 8 to 30 carbon atoms and of which the polyoxyethylene part comprises from 1 to 10 ethoxyl —CH₂CH₂O— groups.

6. Surfactant as claimed in any one of claims 1 to 5, characterised in that the modified surface of the said particle is such that it can be divided by a cross-sectional plane into two surfaces S₁ and S₂ such that:
(i) each of the surfaces S₁ and S₂ represents at least 20% of the total surface of the particle; and
(ii) the density per unit area of organic chains bonded at S₂ is greater than at least 5 times the density per unit area of chains with hydrophobic characteristics bonded at S₁.

7. Surfactant as claimed in any one of claims 1 to 6, characterised in that the bond between the said organic chains and the surface of the particle is ensured by the presence at one of the ends of each of the said chains of an ionic group which induces a complexing bond with a metal cation present on the surface of the particle.

8. Surfactant as claimed in claim 7, characterised in that the particle is a positively charged particle and that the said ionic group which induces the complexing bond is an anionic group.

9. Surfactant as claimed in any one of claims 1 to 8, characterised in that the bonds between the organic chains and the surface of the particle are covalent bonds.

10. Surfactant as claimed in claim 9, characterised in that the particle is formed at least partially of silicon oxide, aluminium oxyhydroxide and/or titanium oxide, this or these oxide(s) or oxyhydroxide being at least present at the surface.

11. Emulsifying composition comprising at least one surfactant as claimed in any one of claims 1 to 10.

12. Emulsifying composition comprising particles of nanometre dimensions based on a metal oxide, hydroxide and/or oxyhydroxide, on the surface of which organic chains with hydrophobic characteristics are bonded, the said composition specifically having emulsifying characteristics such that it permits a stabilised emulsion to be produced of the water-in-oil or oil-in-water type, characterised by a dispersed phase content greater than or equal to 20% in which the average size of the drops forming the dispersed phase is less than or equal to 5 microns.

13. Emulsifying composition as claimed in claim 12, characterised in that it has emulsifying characteristics such that it permits a stabilised emulsion of the water-in-oil type to be produced, characterised by an aqueous phase content greater than or equal to 40%, and in which the average size of the drops is at most 5 microns.

14. Emulsifying composition as claimed in claim 12 or claim 13, characterised in that it is present in the form of an emulsion of the oil-in-water or water-in-oil type, wherein the said particles of nanometre dimensions, on the surface of which the organic chains with hydrophobic characteristics are bonded, are at least partially located at the interfaces of the water/oil type of the said emulsion.

15. Emulsifying composition as claimed in claim 12 or claim 13, characterised in that it is present in the form of a concentrated formulation having a solids content greater than 5% by mass.

16. Emulsifying composition as claimed in claim 15, characterised in that is formed by an ultracentrifugation residue resulting from the ultracentrifugation of an emulsifying composition as claimed in claim 14.

17. Emulsifying composition as claimed in claim 12 or claim 13, characterised in that it is present in the form of a dispersion of the said particles of nanometre dimensions, on the surface of which the organic chains with hydrophobic characteristics are bonded, in a hydrophilic or hydrophobic continuous phase, the said dispersion having a solids content between 10 and 90%.

18. Emulsifying composition as claimed in claim 12 or claim 13, characterised in that it is present in the form of a solid powder.

19. Emulsifying composition as claimed in any one of claims 12 to 18, characterised in that it comprises surfactants which meet the definition of any one of claims 1 to 10.

20. Method of preparation of an emulsifying composition as claimed in any one of claims 11 to 19, characterised in that it comprises a step consisting of forming an emulsion from an aqueous phase and a hydrophobic phase in the presence of a molecular surfactant and of colloidal particles of metal oxide, hydroxide and/or oxyhydroxide of nanometre dimensions having a hydrophilic surface, this step being carried out in such a way as to cause the colloidal particles associated with the molecular surfactants to be anchored at the water/oil interfaces of the emulsion whilst avoiding the transfer of these colloidal particles associated with the molecular surfactant towards the hydrophobic phase, and in which, if the interactions between the particles and the molecular surfactants are sufficiently weak to enable the surfactants associated with the particles to be eliminated easily, then the method comprises a second step of fixing the chains by covalent bonding on the surface of the anchored particles orientated in this way, and a third step of eliminating the molecular surfactants used initially.

21. Method as claimed in claim 20, characterised in that the colloidal particles used have a non-zero surface charge.

22. Method as claimed in claim 20 or claim 21, characterised in that it comprises the steps consisting of:
a) forming a hydrophobic phase and an aqueous dispersion of colloidal particles of metal oxide, hydroxide and/or oxyhydroxide of nanometre dimensions having a hydrophilic surface, the said hydrophobic phase or the said aqueous dispersion comprising a molecular surfactant capable of being associated with the colloidal particles by complexing;
b) producing a mixture by addition of this hydrophobic phase to an aqueous dispersion or by addition of the said aqueous dispersion in the said hydrophobic phase; and
c) subjecting the mixture obtained to emulsification.

23. Method as claimed in claim 22, characterised in that the molecular surfactant used comprises an ethoxylated alkyl chain by way of a chain with hydrophobic characteristics and in that the hydrophobic phase used is a vegetable oil.

24. Method as claimed in claim 22, characterised in that the molecular surfactant used comprises a non-ethoxylated alkyl chain by way of a hydrophobic chain, and in that the hydrophobic phase is a silicone oil.

25. Method as claimed in any one of claims 22 to 24, characterised in that the colloidal particles used in step (b) are particles of cerium oxide, titanium oxide or aluminium oxyhydroxide.

26. Method as claimed in any one of claims 22 to 25, characterised in that the emulsification step (c) is followed by a centrifugation step (d) carried out at a rate of 1 000 to 5 000 r.p.m. for a duration ranging from 2 minutes to 30 minutes.

27. Method as claimed in any one of claims 22 to 26, characterised in that the emulsion obtained at the end of step (c) and the optional step (d) is subjected to a step (e) of heat treatment by bringing the emulsion to a temperature between 40° C. and 100° C. for a duration ranging from 30 minutes to 24 hours.

28. Method as claimed in any one of claims 22 to 27, characterised in that the emulsion obtained at the end of step (c) and the optional steps (d) and/or (e) is subjected to a step (f) of ultracentrifugation so as to obtain a concentrated emulsifying formulation in the form of an ultracentrifugation residue.

29. Method as claimed in claim 28, characterised in that the concentrated formulation resulting from step (f) is subjected to a step (g) comprising the steps consisting of:
(g₁) adding a solvent to the concentrated formulation, the mass of the added solvent being between 0.1 and 10 times the mass of the concentrated formulation used; and
(g₂) filtering the mixture obtained,
by which a phase enriched with solids is obtained.

30. Method of preparation as claimed in claim 21, characterised in that it comprises the steps consisting of:
(α) forming an emulsion comprising molecular surfactants and colloidal particles of metal oxide, hydroxide or oxyhydroxide of nanometre dimensions and having a non-zero charge per unit surface at the interfaces of the water/oil type;
(β) fixing organic chains with hydrophobic characteristics by covalent bonding on the surface of the said particles thus anchored to the interfaces of the water/oil type by utilising a reagent which is soluble in the continuous phase and comprises an organic chain with at least predominantly hydrophobic characteristics; and
(γ) eliminating at least partially the molecular surfactants present at the end of step (β).

31. Method as claimed in claim 30, characterised in that the colloidal particles of nanometre dimensions which are used in step (α) are colloidal particles which comprise, at least on the surface, a silicon oxide, an aluminium oxyhydroxide or a titanium oxide.

32. Method as claimed in claim 30 or claim 31, characterised in that the fixing of the chains with predominantly hydrophobic characteristics carried out during the course of step (β) is effected by condensation of a silanol on the surface of the particle.

33. Method as claimed in any one of claims 30 to 32, characterised in that the step (γ) includes one or more centrifugation step(s) carried out at the rate of 500 to 5 000 r.p.m. for a duration ranging from 3 to 60 minutes.

34. Method as claimed in any one of claims 30 to 33, characterised in that the emulsifying composition obtained at the end of step (γ) is subjected to a step (δ) of ultracentrifugation so as to obtain a concentrated emulsifying formulation in the form of an ultracentrifugation residue.

35. Method as claimed in claim 34, characterised in that the formulation from step (δ) is further subjected to a step (ε) consisting of:
(ε₁) adding a solvent to the concentrated formulation, the mass of the solvent added being between 0.1 and 10 times the mass of the concentrated formulation used; and
(ε₂) filtering the mixture obtained, by which a phase enriched with solids is obtained.

36. Emulsifying composition capable of being obtained according to a method which meets the definition of any one of claims 20 to 35.

37. Emulsifying composition comprising particles of nanometre dimensions based on a metal oxide, hydroxide and/or oxyhydroxide surface-modified by the presence of organic chains with hydrophobic characteristics bonded to the surface, capable of being obtained by a method comprising a step consisting of forming an emulsion from an aqueous phase and a hydrophobic phase in the presence of a molecular surfactant and of the said particles of nanometre dimensions, this step being carried out in such a way as to cause the particles associated with the molecular surfactants to be anchored at the water/oil interfaces of the emulsion whilst avoiding the transfer of these colloidal particles associated with the molecular surfactant towards the hydrophobic phase, a method in which, if the interactions between the particles and the molecular surfactants are sufficiently weak to enable the surfactants associated with the particles to be eliminated easily, then the method comprises a second step of fixing the chains by covalent bonding on the surface of the anchored particles orientated in this way, and a third step of eliminating the molecular surfactants used initially.

38. Emulsifying composition comprising particles of nanometre dimensions based on a metal oxide, hydroxide and/or oxyhydroxide surface-modified by the presence of molecular surfactants associated by complexing bonding with the surface, capable of being obtained by a method comprising the steps consisting of:
a) forming a hydrophobic phase and an aqueous dispersion of colloidal particles of metal oxide, hydroxide and/or oxyhydroxide of nanometre dimensions having a hydrophilic surface, the said hydrophobic phase or the said aqueous dispersion comprising a molecular surfactant capable of being associated with the colloidal particles by complexing;
b) producing a mixture by addition of this hydrophobic phase to an aqueous dispersion or by addition of the said aqueous dispersion in the said hydrophobic phase; and
c) subjecting the mixture obtained to emulsification in such a way as to obtain an emulsion where the particles of nanometre dimensions associated with the molecular surfactant are anchored to the interfaces of the water/oil type.

39. Emulsifying composition comprising particles of nanometre dimensions based on a metal oxide, hydroxide and/or oxyhydroxide surface-modified by the presence of organic chains with hydrophobic characteristics bonded by covalent bonding to the surface, capable of being obtained by a method comprising the steps consisting of:
(α) forming an emulsion comprising molecular surfactants and colloidal particles of metal oxide, hydroxide or oxyhydroxide of nanometre dimensions and having a non-zero charge per unit surface at the interfaces of the water/oil type;
(β) fixing organic chains with hydrophobic characteristics by covalent bonding on the surface of the said particles thus anchored to the interfaces of the water/oil type by utilising a reagent which is soluble in the continuous phase and comprises an organic chain with at least predominantly hydrophobic characteristics; and
(γ) eliminating at least partially the molecular surfactants present at the end of step (β).

40. Use of an emulsifying composition as claimed in claim 13 to stabilise an emulsion of the water-in-oil or oil-in-water type, characterised in that the said emulsifying composition is used in a proportion of 10 to 80% by mass relative to the total mass of the emulsion to be stabilised.

41. Use of an emulsifying composition in the form of a concentrated formulation as claimed in claim 15 or claim 16 in order to stabilise an emulsion of the water-in-oil or oil-in-water type or a multiple emulsion, characterised in that the said concentrated formulation is used in a proportion of 10 to 200% by mass relative to the mass of the dispersed phase of the emulsion to be stabilised.

42. Use of an emulsifying composition as claimed in any one of claims 11 to 19 or 36 to 39, for the formulation of detergent compositions.

43. Use of an emulsifying composition as claimed in any one of claims 11 to 19 or 36 to 39, for the manufacture of a film or of a material having anti-UV properties, anti-corrosion properties or opacifying properties.
